(19) United States
(12) Patent Application Publication
(10) Pub. No.: US 2019/0219717 A1
(43) Pub. Date: Jul. 18, 2019

(54) SOURCE ARRAY FOR MARINE SEISMIC SURVEYING

(71) Applicant: POLARCUS DMCC, Dubai (AE)

(72) Inventors: Erik GODØY, Nesbru (NO); Edward HAGER, Singapore (SG)

(73) Assignee: POLARCUS DMCC, Dubai (AE)

(21) Appl. No.: 16/326,399

(22) PCT Filed: Oct. 3, 2017
(86) PCT No.: PCT/NO2017/050259

§ 371 Date: Feb. 19, 2019

(30) Foreign Application Priority Data
Oct. 4, 2016 (NO) 20161589

(51) Int. Cl. G01V 1/38; G01V 1/00; G01V 1/137

(52) U.S. Cl. CPC G01V 1/3861; G01V 1/137; G01V 1/3808; G01V 1/006

(57) ABSTRACT

The invention provides a system (100) for marine seismic surveying, comprising a towing vessel (110) with a controller, a source array (120) and a receiver array (130) with several streamers (131). The source array (120) comprises n>4 identical subarrays (121) configured as at least (n−1) seismic sources S₁, . . . , Sₙ₋₁, wherein adjacent subarrays (121) are part of at least two sources Sᵢ, Sⱼ at different times.

### BACKGROUND

### Field of the Invention

The present invention concerns a system and method for a seismic survey using towed streamers.

### Prior and Related Art

In a marine seismic survey, one or more surface vessels tow seismic sources and streamers a few metres below a sea surface. The seismic sources emit powerful acoustic pulses, shots, which penetrate into an underground formation. Interfaces between materials with different elastic properties reflect and refract the waves, and seismic receivers, e.g. hydrophones, in the streamer array record the echoes for later analysis. For simplicity, we will use examples where a survey vessel tows a source array containing seismic sources and a streamer array containing seismic receivers behind the source array. Configurations with multiple vessels are included in the present invention. This invention can also be used by a source vessel and OBN/OBC.

As used herein, a seismic source comprises airguns with different volumes that are released to form a pulse by interference. The source may comprise one, two, or more adjacent subarrays in order to release a pulse with sufficient acoustic energy to penetrate the earth and produce detectable echoes. Further, the direction along the streamers is known as ‘inline’, and the detected seismic data are typically ‘inline data’. ‘Crossline’ refers to the direction perpendicular to the inline direction. Data from one receiver is known as a ‘trace’, and there are typically hundreds of receivers in one streamer.

In mathematical terms, a survey aims at determining boundary conditions for known seismic equations by discrete sampling a wavefield of pressure waves (P-waves). The wavefield has a limited bandwidth and can be described by functions having a Fourier-transform. Most seismic waves fall into this category. Thus, the Nyquist-Shannon theorem determines minimum temporal and spatial sampling frequencies required to reconstruct the wavefield. In other words, a subsequent processing and mapping necessarily depends on an appropriately planned and executed seismic data acquisition.

Common methods of data acquisition minimises the error terms in a Taylor expansion. For example, several text books include an example of centred measurements in which 1D expansions of functions F(x−Δx) and F(x+Δx) are added and subtracted to provide estimates of F′(x) and F″(x) with error terms O((Δx)³). The 3D version yields the gradient ∇F and Laplacian ∇²F with similar error terms, which are negligible when Δx is small. In a typical streamer array, the inline and crossline distances between adjacent receivers are small compared to the vertical distance so the assumption of small Δx holds. Similarly, a small vertical distance between receivers ensures a small temporal difference Δt and thus may improve estimates for (particle) velocities and accelerations. However, the inline distance between two arbitrary receivers may be 10-20 kilometres, which is not small compared to a reflection point a few km or less below the sea surface.

US20130250721A1 discloses inter and extrapolating streamer data for wavefield reconstruction. Specifically, differences between measurements along the streamers represent inline derivatives. These inline derivatives replace first and/or second order derivatives of crossline terms in a 2D Taylor expansion of the wavefield. The resulting wavefield is more accurate than a wave field obtained by simple averaging, and can be useful, for example, for comparing results from separate surveys in a 4D time-lapse series. However, there is no way to reconstruct an under-sampled signal or wavefield, e.g. a bandlimited signal or wavefield sampled in time and space below the corresponding Nyquist limits.

A survey performed in a source-gather (s, g) coordinate system can be sorted into a standard common midpoint (CMP) gather by assigning each trace to a reflection point or bin midways between the seismic source and the seismic receiver that recorded the trace, and then sorting the traces by bin. Neither interpolation nor wavefield reconstruction is required in this standard procedure provided an adequate fold can be obtained for each bin. As used herein, CMP includes reflection points on surfaces inclined to a horizontal plane.

Usually, it is assumed that the traces assigned to a bin is somehow connected and that stacking improves the signal-to-noise ratio (SNR). Specifically, random or incoherent noise contribute both negatively and positively to a sum, and so cancel by addition whereas the sum enhances a coherent signal. Before stacking, moveout correction removes the moveout by known methods. Moveout is the apparent time shifts due to the horizontal spacing between receivers recording the signal from a shot and the finite velocity of acoustic waves. After stacking, the sum is typically divided by fold or balanced to a common rms-value to permit comparison of bins with different folds.

A standard gather comprises 12 parallel streamers 100 m apart with inline receiver spacing 25 m and a bin size 12.5×12.5 square metres. A first objective of the present invention is to improve the sampling relative to a standard gather without a significant raise in survey costs. For example, the objective may involve obtaining an adequate fold in bins 6.25×6.25 m2 without a significant increase in survey costs. In addition or alternatively, the objective may involve performing all or part of the survey as a standard gather at a lower cost.

U.S. Pat. No. 3,747,055 (Greene) discloses methods redundant shooting. In a linear example, n-fold redundant shooting comprises actual shot points that are displaced D/n, 2D/n, . . . , (n−1)D/n from nominal inline locations displaced a fixed distance D apart. The result is a number of reflection points D/2n apart, which may be assigned to a greater number of bins. In general, a deterministic firing sequence that is “less random” than the incoherent noise achieves the same effect. Greene also discloses using spatial domain operators to enhance the accuracy of the data for a given bin. For example, FIG. 6E in Greene illustrates an operator with length L=17 traces. The central point or current bin is assigned a weight of 85%, and traces as far as 8 bins away in either direction are taken into account—the most remote traces with weight 1%. The length is meaningful only with respect to the wavelength λ of the seismic waves to be sampled, so Greene introduces the dimensionless variable L/λ. Virtually no distortion is introduced in the response of the weighted operator in the wavelength domain for small wavelengths. In short, weighted spatial filters may be used with pseudo-random deterministic firing to improve the results for large wave numbers compared to a standard CMP-gather. Further, as seismic waves can be described by functions having a Fourier transform, the Nyquist-Shannon theorem applies to a spatial operator of finite length and determines a minimum spatial frequency for avoiding aliasing of large wavenumbers k=2π/λ.

A source array for seismic exploration comprises several subarrays, for example six or eight. Each subarray contains several airguns, and is charged with pressurized air and released as a unit. The number of subarrays is constrained by the space available for compressors and other required equipment aboard the survey vessel.

U.S. Pat. No. 4,868,793 A discloses a system and method where several laterally spaced subarrays are fired simultaneously and constitute one seismic source. Several such sources are fired sequentially in a round robin scheme. Firing several subarrays at the same time releases more acoustic energy per shot than firing one subarray per shot. The increased energy can increase SNR in the received waves. Accordingly, the minimum number of subarrays, and hence the number of airguns per source can be determined by a desired SNR: If the source does not release sufficient acoustic energy, the SNR may drop below acceptable levels.

The period of the round-robin scheme must be larger than a maximum charge time required to charge a subarray, such that every subarray may be fired during each cycle. Thus, the source array may be divided into n sources, the period T may be divided into T/n intervals, and a source may be fired at the end of each interval. For example, a charging time T of 10 seconds and two sources may yield a shot with sufficient acoustic energy for an acceptable SNR at most every 5 seconds.

Relevant techniques for acoustic acquisition by streamers may be found in related fields of technology. For example, U.S. Pat. No. 4,509,151 discloses a system with receivers arranged in groups along towed streamers. By changing the combination of groups, the frequency response and directional sensitivity of the array can be selectively analysed. While the system in U.S. Pat. No. 4,509,151 is designed for classifying and identifying marine mammals and fish, several features may be applied to a seismic array without inventive effort.

Seismic streamers are typically kept at a desired depth, below the sea surface and in a desired orientation by means of so-called ‘birds’. Streamers are typically several km long, and the receivers will deviate randomly from an ideal position. In addition, water currents at the towing depth may cause the streamer to drift sideways with respect to the towing direction. The resulting deviation is known as ‘feather’. The feather angle is the angle between the towing direction and the longitudinal axis of the streamer.

AU 661000B2 (Marschall/Prakla) discloses a method for marine seismic data acquisition in which at least one streamer is guided with its longitudinal axis parallel to the line of course and a plurality of additional streamers deployed on either side of the line of course in a fan arrangement. Thereby, each pass over a survey area covers a wider area.

U.S. Pat. No. 6,691,038 B2 (Zajac/WesternGeco) discloses a seismic streamer array tracking and positioning system comprising a towing vessel for towing a seismic array and an array comprising a plurality of seismic streamers. An active streamer positioning device (ASPD) is attached to at least one seismic streamer for positioning the seismic streamer relative to other seismic streamers within the array. A master controller is provided for issuing positioning commands to each ASPD to adjust a vertical and horizontal position of a first streamer relative to a second streamer within the array for maintaining a specified array geometry. The system accounts for environmental factors. Zajac describes different receiver arrays, including one with streamers at different depths to improve temporal resolution.

A general objective of the present invention is to solve or reduce at least one of the problems and shortcomings above, while retaining the benefits from prior art. A more specific object of the invention is to improve spatial and temporal resolution of the sampled wavefield to allow faster acquisition of a standard gather or improve the resolution with an effort similar to the effort required for a standard gather in prior art.

### SUMMARY OF THE INVENTION

These objectives are achieved by a system according to claim 1.

In a first aspect, the invention provides a system for marine seismic surveying, comprising a towing vessel with a controller, a source array and a receiver array with several streamers. The source array comprises n≥4 subarrays configured as at least (n−1) seismic sources S₁, . . . Sₙ₋₁, wherein adjacent subarrays are part of at least two sources Sᵢ, Sⱼ at different times.

Combining subarrays into a source permits more energy per pulse in each shot at the cost of one additional subarray. Each source normally comprises two adjacent subarrays for precise location. However, sources comprising three or more subarrays are anticipated. The subarrays are usually arranged in a row. In this case, the first and last subarrays are not adjacent and do not form a source. Thus, in most embodiments n subarrays form n−1 sources, all subarrays except the first and last are part of at least two sources and the first and last subarrays in the row are part of one source each, namely S₁ and Sₙ₋₁, respectively. If the subarrays are arranged in a polygon, n subarrays form n sources and all subarrays are part of at least two sources.

Preferably, two sources Sᵢ, Sⱼ fired within a minimum time interval must be separated by a minimum distance. This ensures that the pulses are separable in time-space and fk-space.

Preferably, each source Sᵢ comprises at least two adjacent subarrays. Adjacent subarrays ensure that the source is small compared to seismic wavelengths of interest and thus that a Dirac's delta is a reasonable approximation for the pulse.

The controller is preferably configured to release at least one acoustic pulse from each seismic source Sᵢ during each period of twice the recharging time T for a subarray. This allows a round-robin scheme in 2T. Embodiments include schemes where the charging times extend beyond 2T and alternatives are all embodiments where at least one source is not fired within 2T from the first.

The system according to any preceding claim, wherein a source Sᵢ is fired with a random offset Δt in consecutive periods nT. The random offset can have a triangular probability density function to counteract coherence between input and the signal in the discrete sampling system.

The source array may be displaced laterally from a centreline through the receiver array. These embodiments include source arrays towed by vessels other than the vessel towing the receiver array.

In addition or alternatively, the source array may be located behind the receiver array. The location of pulses in time and space must be known, but the skilled person may of course deploy one or more source arrays around the receiver array to achieve the desired illumination of the underground.

Likewise, the skilled person may use any streamer configuration known in the art, including fanned and curved configurations. While feathering due to underwater currents has been a challenge, e.g. due to a subsequent need for infill, data from feathered streamers have been put to good use since the start of marine seismic surveying several decades ago.

### BRIEF DESCRIPTION OF THE DRAWINGS

The invention will be described by way of example and reference to the accompanying drawings, in which:

FIG. 1 illustrates a system according to the invention;

FIG. 2 illustrates a general scheme for source configuration;

FIG. 3 illustrates a special case of the scheme in FIG. 2;

FIG. 4 illustrates an embodiment with a fanned streamer configuration;

FIG. 5 illustrates other obvious configurations of a discrete data acquisition device; and

FIG. 6 illustrate a fanned and feathered configuration common in the art.

### DETAILED DESCRIPTION OF A PREFERRED EMBODIMENT

The drawings are schematic and intended to illustrate the invention. Thus, they are not to scale, and numerous details known to one skilled in the art are omitted for clarity.

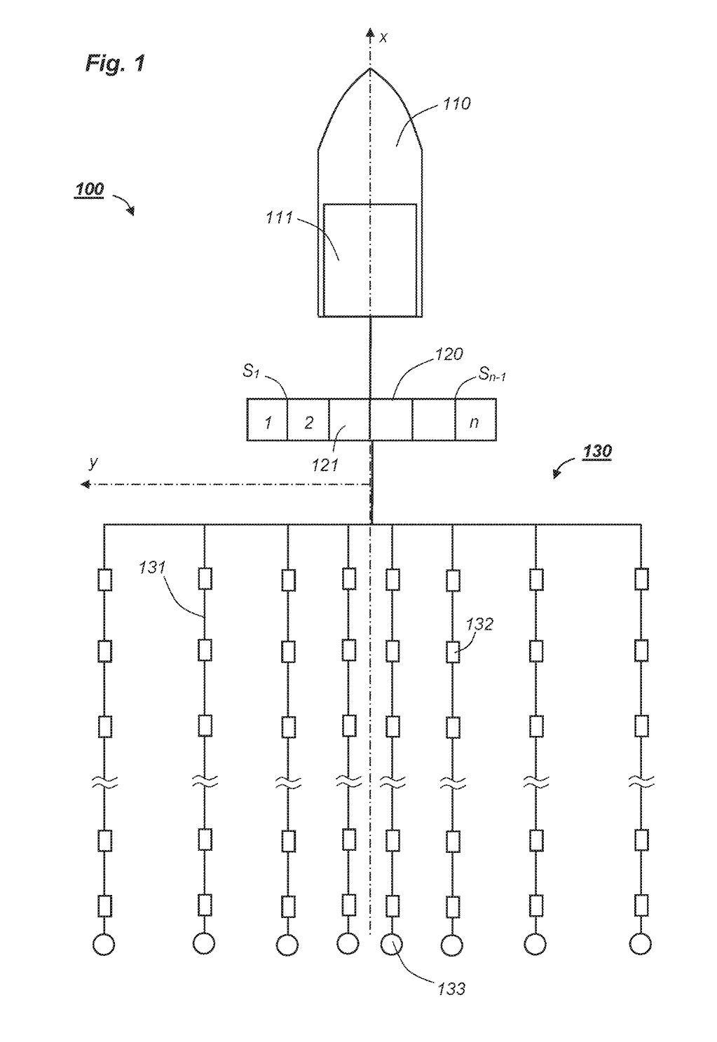

FIG. 1 illustrates a system 100 for marine seismic surveying, the system comprises a seismic survey vessel 110 towing a source array 120 and a receiver array 130. Here, an x-axis along the centreline of the survey vessel 110 indicates the direction of towing and a y-axis indicates a crossline direction.

The source array 120 comprises n subarrays 121 numbered 1 to n arranged in the crossline direction. Subarrays 1 and n are too far apart to form a source, so n subarrays form at most n−1 sources S₁-Sₙ₋₁. Each source Sᵢ is located on the line between subarray i and the adjacent subarray i+1. The main benefit is that each of n−1 sources emits twice the energy of a single subarray at the cost of one extra subarray. The acoustic pulses emitted during the survey should be as equal as possible, so the sources S₁-Sₙ₋₁ should have identical specifications. In this case, the resolution is half the source separation. That is, the space between sources may, for example, be 12.5 m for a crossline resolution of 6.25 m. The source arrays can also be mirrored in order to control directivity in shallow water zones.

Specifically, each source Sᵢ should be “small” in time and space compared to seismic wavelengths of interest. If not, the approximation of a pulse with Dirac's delta localised in time and space becomes uncertain. Passing a significant uncertainty through a nonlinear process may render the resulting model of the underground even more uncertain or invalid. Moreover, the shots should contain approximately the same amount of energy distributed in narrow pulses of similar width and height. Thus, we use two subarrays per source in the following examples. However, a source may comprise 3 or more subarrays depending on the seismic wavelength of interest and the size of the subarrays. Likewise, the subarrays may be arranged in a polygon rather than in a row. In practice, this would mean towing the subarrays at different depths to obtain separations comparable to that of two sub arrays side by side. We believe the added complexity outweighs the benefit of an n^{th} source in a source array already containing (n−1) sources in most practical embodiments.

The receiver array 130 in FIG. 1 has eight streamers 131. However, it is fully feasible to tow 12 or more streamers as noted in the introduction. Lead-in cables, paravanes, birds and other means to tow, spread and steer the streamers 131 are omitted from FIG. 1, but will be part of a real embodiment. Each streamer 131 comprises several seismic receivers 132, e.g. hydrophones of known design, and a tail buoy 133, also of a known type. Today, streamers 131 are typically 1-20 km from their head end to the tail buoy 133. An uneven separation of streamers from inner (closest to centreline) to outer (furthest from centreline) may be utilised to design a pattern of CMP locations per area covered by the in-sea equipment and taken advantage of in order to increase acquisition efficiency.

In that case, the distance between the streamers closest to the centreline x is smaller than the distance between the outermost streamers. Thus, the midpoints between the receivers 132 and one of the sources 121 vary. This increases the density of reflection points as described by Greene mentioned in the introduction.

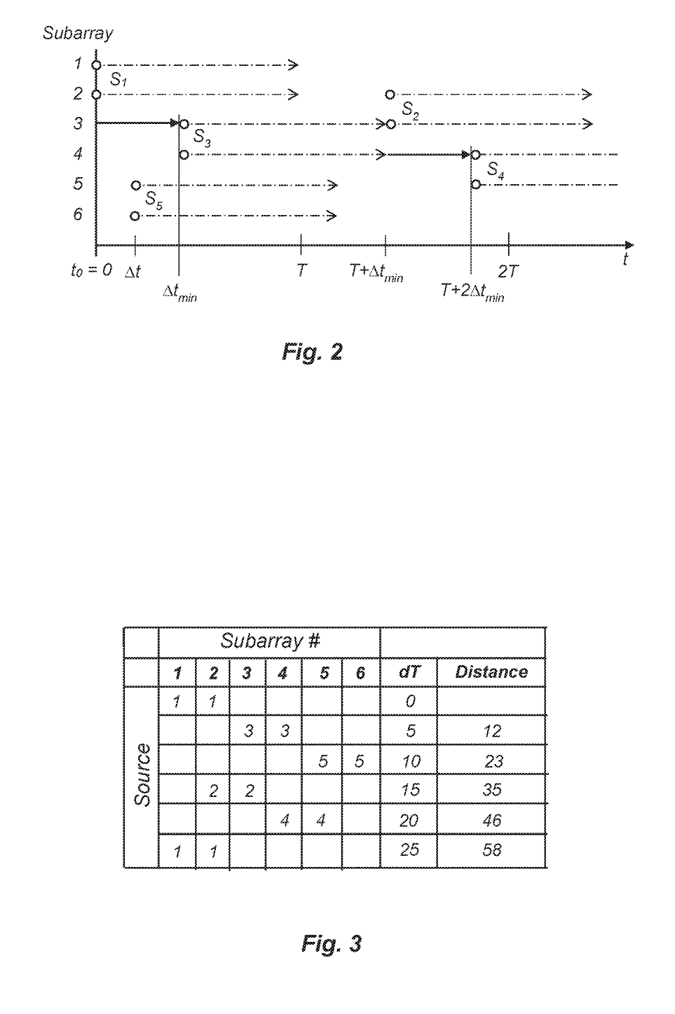

FIG. 2 illustrates that the sources Sᵢ must be separated in time and space to be discernible from each other. In this example, we assume that adjacent sources Sᵢ and Sᵢ₊₁ must be separated by a minimum time interval Δtₘᵢₙ and that two sources Sᵢ and can be fired within this time interval if they are not adjacent, i.e. with Δt<Δtₘᵢₙ if j≠(i±1).

In FIG. 2, each subarray is represented by a circle indicating a shot and an open arrow indicating a time T required for recharging. Source S₁ comprises subarrays 1 and 2 and is fired at t₀=0. Source S₃ is fired at Δtₘᵢₙ for a reason explained below. S₅ is neither adjacent to S₁ nor to S₃ and may thus be fired at an arbitrary time Δt<Δtₘᵢₙ.

At T+Δtₘᵢₙ, recharging subarrays 3 and 4 is complete, and subarray 3 is combined with subarray 2 into source S₂. Subarray 4 is also recharged, and might be combined with subarray 5 into S₄. However, S₄ and S₅ are adjacent, and must thus be separated at least by Δtₘᵢₙ. Keeping in mind that Δt is arbitrary and can be close to zero, S₄ cannot be fired before T+2Δtₘᵢₙ. S₃ was not fired until t₀+Δtₘᵢₙ for the same reason.

If we require T+2Δtₘᵢₙ<2T, it follows that Δtₘᵢₙ<T/2. With this requirement, t₀ may be shifted to Δt and the process above repeated with S₅ replacing S₁ and S₄ replacing S₃.

The arbitrary interval Δt may be fixed, e.g. 0 or Δtₘᵢₙ/r, where r is a real scalar. Alternatively, Δt may be a random variable. Pseudorandom noise with a triangular probability density functions (pdf) added to the input is generally known to minimise autocorrelation between signals and input in discrete systems, so a pseudorandom Δt with a triangular pdf may be preferred.

Moreover, the scheme in FIG. 2 applies to any number n≥4 subarrays. For example, removing subarray 6 would remove S₅, but leave S₁-S₄ intact. There would still be room for a fixed or random Δt in the interval [Δtₘᵢₙ, T>.

Further removing subarray 5 would leave S₁-S₃ intact and permit firing of S₂ within 2T from t₀ when S₁ was fired. The survey may need a minimum time separation Δtₘᵢₙ<2T/3, e.g. because the real filtering is done after a Fourier transform to an fk-domain. In this case, subarray 2 defines a minimum time 2T for completing the firing sequence S₁, S₃, S₂ in FIG. 2. Adding subarray >6 would permit extra arbitrary variables Δtₚ.

FIG. 3 illustrates a round-robin shot sequence with fixed intervals. The period of the round-robin scheme has historically been dictated by the desired seismic record length in milliseconds due to the inability to record and subsequently separate overlapping records.

Advances in acquisition and processing technology now permit this invention to become practical. The period dictates the seismic fold. As in FIG. 2, six subarrays form 5 sources S₁-S₅, each comprising two adjacent subarrays i and i+1. For convenience, only the indices of the sources are shown in FIG. 3. We assume a recharge time of 6 seconds. Noting that sources 1 and 2 include subarray 2, which needs 6 seconds for recharging, source 2 is not fired immediately after source 1. Rather, the sources are fired in the order 1, 3, 5, 2, 4 at fixed intervals of 3 seconds. The column “Distance” illustrate the distance traveled with a typical towing speed.

The scheme in FIG. 3 is a special case of the general scheme in FIG. 2. For example, setting Δt=0 and Δtₘᵢₙ=T/2 in FIG. 2 would yield an alternative shot sequence 1, 5, 3, 2, 4. In both FIGS. 2 and 3, the recharge time for source S₄ extends beyond 2T.

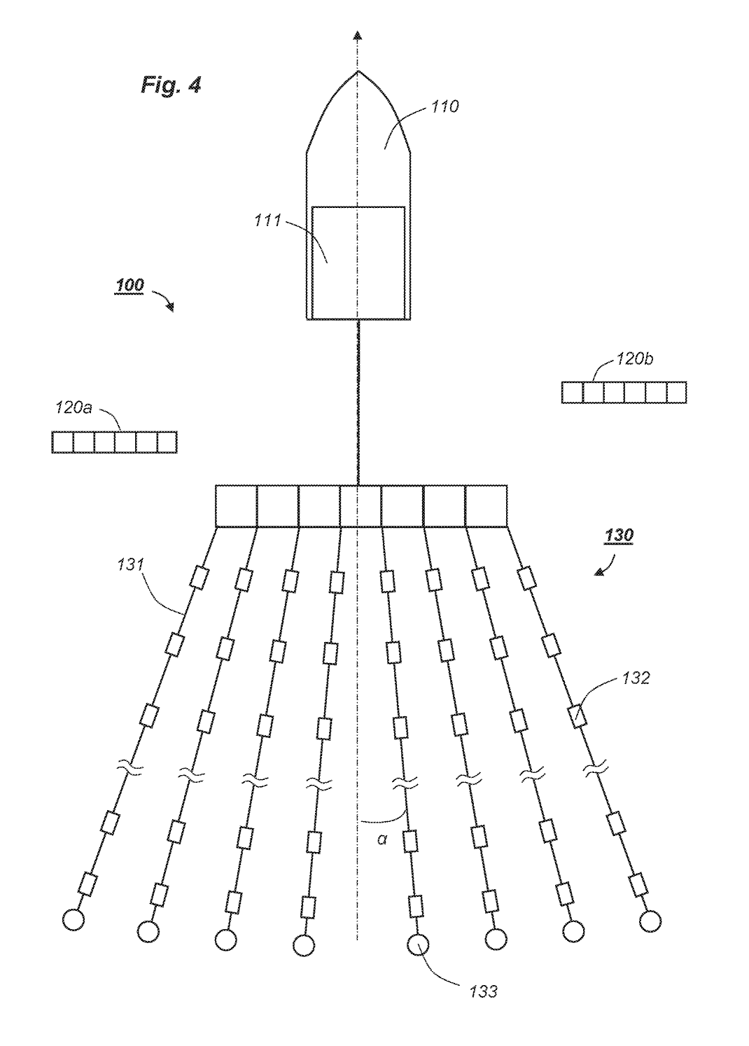

FIG. 4 shows an embodiment with two source arrays 120a and 120b displaced from the towing line. One or both source arrays 120a, 120b may be towed by the vessel 110 or by separate vessels. Either way, the subarrays are combined into sources as described above in order to improve the illumination of the underground from different angles.

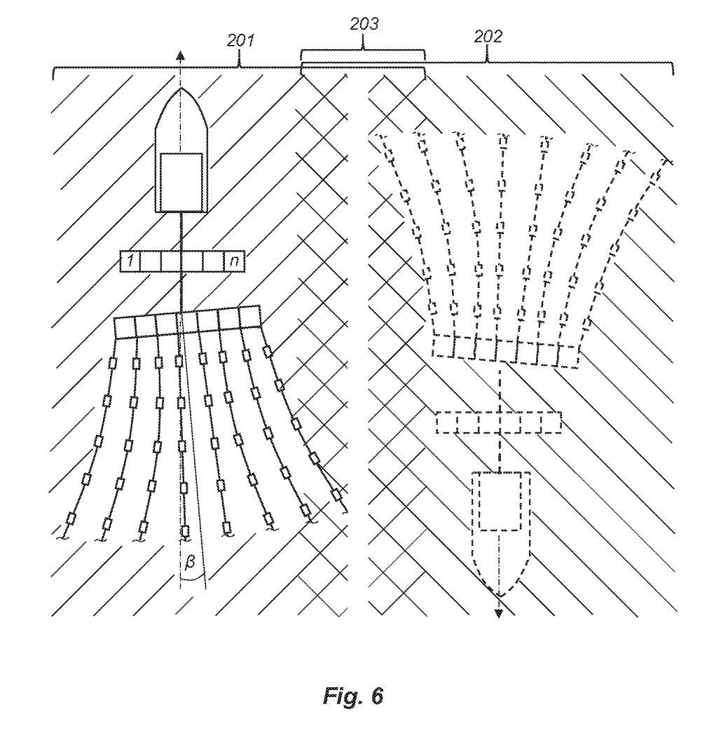

FIG. 4 also show a fanned out streamer configuration, i.e. a configuration in which each streamer 131 forms an angle α≠0 with the centreline. The main benefit of a fan is that a larger area is covered in each leg of the survey. The main challenge is towing the fan in adjacent legs to provide a sufficient overlap between the outermost streamers, yet not so much that the benefit of the fan disappears. This will be further discussed with reference to FIG. 6.

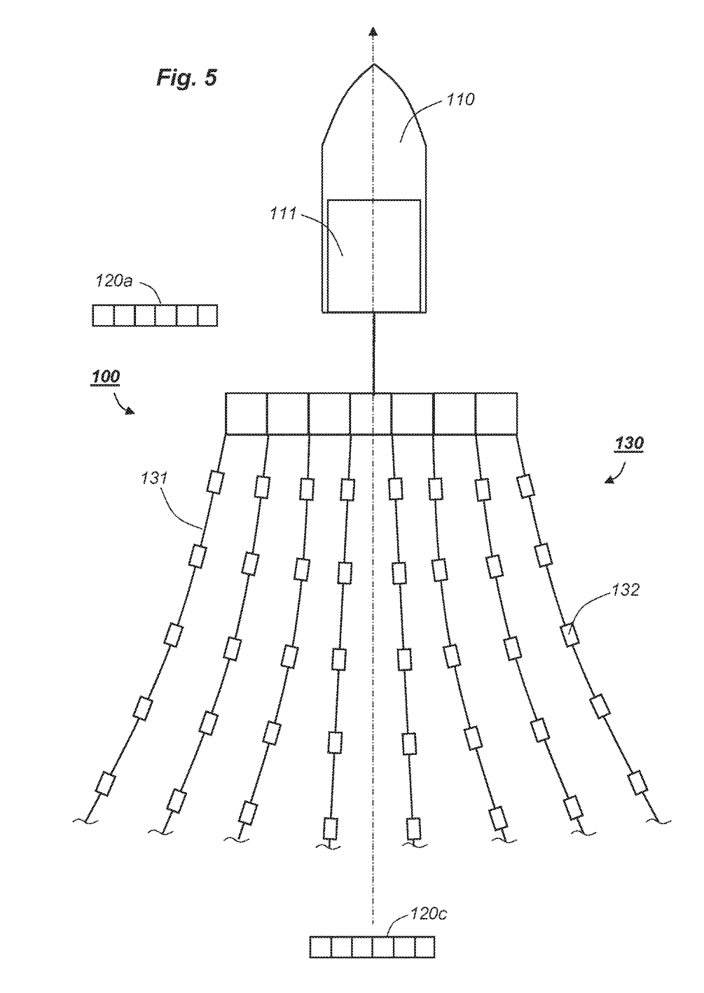

FIG. 5 further illustrates configurations lacking an inventive step as such. Specifically, the vessel 110 may have any location, speed and heading determined by the survey at hand. Similarly, it is irrelevant whether source array 120a is towed by vessel 110 or another vessel as long as the locations of each source and each receiver 132 in time and geodetic coordinates are sufficiently accurate. The location of the source array 120c behind the receiver array 130 may affect a moveout correction, but does not alter any principle for discrete sampling of a wavefield or marine seismic data acquisition. Finally, it is generally known that a freely suspended cable assumes a catenary or hyperbolic shape to minimise tension, stress and strain. Likewise, it is generally known that the hyperbolic shape changes to a parabolic shape when an inline pull is applied to the cable. Thus, minimising the noise from birds generally means to use birds as little and possible, and allow the streamers to assume the parabolic shape in FIG. 5. Using birds as little as possible is not inventive. Neither is the resulting parabolic shape of the fanned streamers 131 in FIG. 5.

In FIG. 6, the survey vessel tows the receiver array in FIG. 3 to cover an area 201. Due to currents, the centreline of the receiver array is displaced from the towing direction by a feather angle β. Such feathering may be significant. For example, β=1° causes a crossline deviation of 175 m for a receiver 10 km from the leading end.

The dotted towing vessel illustrates an adjacent return path covering the area 202. The areas 201 and 202 overlap in the overlap area 203, which should be wide enough to ensure proper coverage by the sparsely spaced aft receivers, but not so wide that the number of measurements becomes unnecessarily high—as would the time and cost for the survey. Such feathering is well known to anyone of ordinary skill in the art, and may affect the position and orientation of a source array. As indicated above, the configuration of the data acquisition device is irrelevant as long as it provides a proper discrete sampling of the responses or wavefield caused by a series of Dirac's deltas localised in time and space.

Thus, the invention defined in the appended claims regards an inventive source configuration and shot sequence, not configurations of a discrete data acquisition device that are known or obvious as such. The skilled person will recognise the above and other obvious embodiments within the scope of the present invention.

1-10. (canceled)

11. A system for marine seismic surveying, comprising:
a towing vessel with a controller, a source array and a receiver array with several streamers, wherein the source array comprises n≥4 identical subarrays configured as at least (n−1) seismic sources S₁, . . . Sₙ₋₁, wherein adjacent subarrays are part of at least two sources Sᵢ, Sⱼ at different times.

12. The system according to claim 11, wherein two sources Sᵢ, Sⱼ fired within a minimum time interval are separated by a minimum distance.

13. The system according to claim 11, wherein each source Sᵢ comprises at least two adjacent subarrays.

14. The system according to claim 11, wherein the controller is configured to release at least one acoustic pulse from each seismic source Sᵢ during each period of twice the recharging time T for a subarray.

15. The system according to claim 11, wherein a source Sᵢ is fired with a random offset Δt in consecutive periods T.

16. The system according to claim 11, wherein the source array is displaced laterally from a centreline through the receiver array.

17. The system according to claim 11, wherein the source array is located behind the receiver array.

18. The system according to claim 11, wherein the receiver array has a fanned configuration.

19. The system according to claim 11, wherein the receiver array has a curved configuration.

20. The system according to claim 11, wherein the receiver array has a feathered configuration due to underwater currents at a towing depth.
